(19) United States
(12) Patent Application Publication
(10) Pub. No.: US 2006/0220529 A1
(43) Pub. Date: Oct. 5, 2006

(54) Large scale transportable illuminated display

(76) Inventors: Ivan Pawlenko, Holland, PA (US); Larry Samson, Langhorne, PA (US)

Correspondence Address: Lucent Technologies Inc.;Docket Administrator - Room 3J-219, 101 Crawfords Corner Road, Holmdel, NJ, 07733-3030, US

(21) Appl. No.: 11/095,446

(22) Filed: Mar. 31, 2005

(51) Int. Cl. H01J 1/62

(52) U.S. Cl. 313/498

(57) ABSTRACT

A large programmable display includes a thin flat sheet of flexible non-conducting material on which wires are mounted via an adhesive. The wires have low impedance segments and are coupled to light emitting displays. An additional sheet of a flexible non-conducting material may be used to create a seal to protect against infiltration to the wires and LEDs of external environmental elements. Advantageously, the display may be rolled up to be transported, and, later unfurled to be operated.

### TECHNICAL FIELD

This invention relates to the art of electronic displays.

### BACKGROUND OF THE INVENTION

Various electronic displays exist that are large, but they are costly to manufacture and rigid in structure. These prior art displays are difficult to transport due to their size and rigidity.

There is at least one relatively small prior art electronic display that is somewhat flexible. This display uses a flexible substrate, such as plastic, on which are sprayed silver-based wires. The sprayed-on wires couple an array of light emitting diodes (LEDs) to a display controller, which controllably illuminates ones of the LEDs to convey information. Disadvantageously, such sprayed-on wires have relatively large impedances, as compared with conventional copper wires, thereby limiting the size of the display. Also, disadvantageously, this prior art display was costly to manufacture due to the silver content of the wires. Further, disadvantageously, the sprayed-on wires tend to degrade with time and usage, resulting in failure.

### SUMMARY OF THE INVENTION

We have recognized that the problems of the prior art in achieving a large, easily transported display, can be overcome, in accordance with the principles of the invention, by a display that employs a flexible substrate on which are mounted any type of light source, e.g., incandescent lights, halogen lights, fluorescent lights, etc., especially small light emitting displays, e.g., LEDs, which are coupled to discrete flexible wires that are bonded to the substrate and have at least some segments with an impedance lower than can be achieved by similarly-sized spray-on-wires of the prior art. The wires are adapted to couple the plurality of light emitting displays to a controller, e.g., via a connector or interface.

Advantageously, due to the low impedance of the wires, larger displays can be achieved than is possible with the prior art spray-on wire technique. Also advantageously, due to the flexibility of the substrate and wires, such a display is itself relatively flexible, and, hence can be compacted, e.g., bent, twisted, and rolled-up to a limited degree, without causing damage to the wires and the light sources of the display. Further advantageously, the ability to be compacted allows the display to be more easily transported than the large size, rigid, prior art displays.

In one embodiment of the invention, insulated conventional copper wire segments are coupled to LEDs using conventional techniques, e.g., soldering, push-in wire, crimp-on contacts, installation display connection (IDC), etc. The wires, and also possibly the LEDs, are bonded, e.g., with an adhesive, to the same surface of a substrate made of at least one thin flat sheet of flexible non-conducting material, e.g., plastic, such as Mylar® or Kapton®. A second layer of a flexible non-conducting material may be bonded to the substrate over the wires and the LEDs so as to create a seal to protect against infiltration to the wires and the LEDs of external environmental elements.

In another embodiment of the invention, the wire segments employed are non-insulated. When non-insulated wires are used in the display, a first set of wires are coupled to a surface of a first sheet of a thin flat flexible non-conducting material. The anodes of the LEDs are bonded to the wires. A second set of wires are similarly bonded to a surface of a second sheet of thin flat flexible non-conducting material. A grid may be formed when the two sheets are coupled. The second sheet may have pre-punched holes through which the cathodes of the LEDs on the first sheet may be connected to the wires on the second sheet to complete the basic display. The second sheet, which is interposed between the first and second set of wires, provides the necessary insulation for the wires. A third sheet of flexible non-conducting material may be bonded with an adhesive to the second sheet to create a seal to protect against infiltration to the wires and LEDs of external environmental elements.

In operation, the display may be coupled to a programmable controller, which causes appropriate ones of the LEDs to illuminate, preferably to result in the display of a human understandable message. The programmable controller may be 1) integrated with, e.g., mounted on, one of the sheets of flexible non-conducting material that makes up the display, or 2) part of a separate unit that can be coupled to the display.

### BRIEF DESCRIPTION OF THE DRAWINGS

FIG. 1 shows a top view of an exemplary embodiment of the present invention;

FIG. 2 shows a partly rolled-up version of an exemplary embodiment of the present invention;

FIG. 3 shows another exemplary embodiment of the present invention; and

FIG. 4 shows a version of an exemplary embodiment of the present invention that employs non-insulated wire.

### DETAILED DESCRIPTION

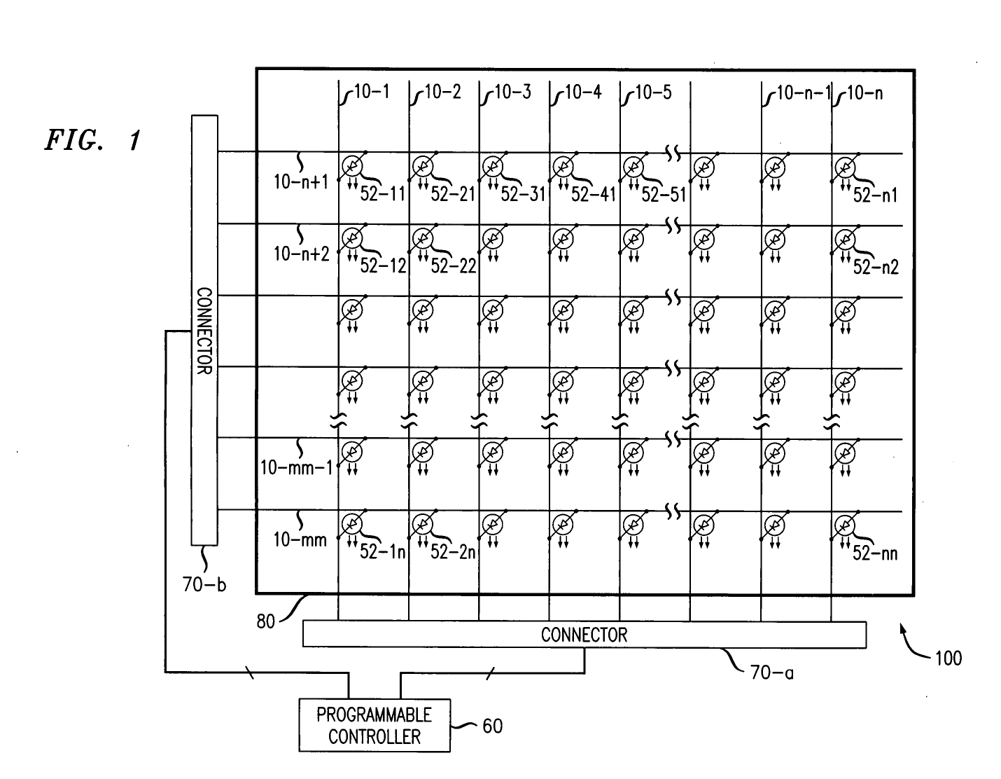

FIG. 1 shows a top view of an exemplary display arranged in accordance with the principles of the invention. More particularly, shown in FIG. 1 is flexible substrate 80, discrete flexible wires 10-1 to 10-mm, collectively hereinafter wires 10, and a plurality of light emitting displays, e.g., LEDs 52-11 to 52-nn, collectively hereinafter LEDs 52.

Substrate 80 is a thin flat sheet of flexible non-conducting material of a type that allows display 100 to be bent, twisted, and rolled-up to a limited degree without causing damage to wires 10 and LEDs 52 in display 100. Typical examples of such material are plastics such as Mylar® or Kapton®.

Wires 10, which are mounted on substrate 80, may be copper wires having a size of 18 to 20 American Wire Gauge (AWG) standard. For example, they are 0.3 to 0.4 inches in diameter. In addition, wires 10 have at least some segments that have a lower impedance than can be achieved by similarly-sized spray-on-wires of the prior art. Such low impedance wires allow for the design and manufacture of large-size flexible displays, e.g., having a display area greater than 9.5 inches by 7 inches, thereby overcoming the size limitations of the smaller somewhat flexible prior art electronic display. For example, at least some of wires 10 may have some conventional copper wire segments, which are considered to add essentially no resistance from a circuit analysis point of view for this type of application. Also, low impedance wires 10 in display 100 are insulated wires.

A thin coating of an adhesive is applied to substrate 80 to bond wires 10 onto the substrate 80. Preferably, the adhesive should have the property that it does not become rigid as it ages. One exemplary such adhesive is rubber cement.

LEDs 52 are coupled to wires 10 using conventional techniques, e.g., soldering, push-in wire, crimp-on contacts, installation display connection (IDC), etc. LEDs 52 a) may each be the same color, b) may each be a different color, or c) may be any combination of colors, depending upon the requirements of the intended application of display 100. For example, displays used by public officials for emergencies may have LEDs with only a single color, while displays used for sporting events may employ LEDs of various different colors. Also, the size of LEDs 52 and the distance between LEDs 52 will vary in accordance with the required size and resolution required for the application to which display 100 is to be used. Those of ordinary skill in the art will readily be able to select LEDs of appropriate color and size, as well as determine the appropriate spacing.

In FIG. 1, all of the cathodes of a column of LEDs 52 are connected by a single one of wires 10. For example, wire 10-1 connects the cathodes of LEDs 52-11 through LEDs 52-1n. Also, all of the anodes of a row of LEDs 52 are connected by a single one of wires 10. For example, wire 10-n+1 connects the anodes of LEDs 52-11 through LEDs 52-n1.

The columns of wires 10 are terminated at connector 70-a. The rows of wires 10 are terminated at connector 70-b. Connectors 70-a and 70-b, which may form a single connector and are hereinafter referred to as connectors 70, may be coupled to programmable controller 60, which supplies signals to operate LEDs 52 in the appropriate pattern to make visible the messages to be displayed. Programmable controller 60 may contain a current limiting resistor. The wires coupling connector 70 to the programmable controller 60 may be conventional copper wire.

Programmable controller 60 may be 1) integrated with, e.g., mounted on, one of the sheets of flexible non-conducting material that makes up display 100, or 2) a separate unit coupled to display 100. In operation, programmable controller 60 may select the column number and row number of a particular LED, so that a signal is transmitted via connector 70-b to the one of wires 10 connected to the LED anode, and the signal returns to programmable controller 60 after a voltage drop across the LED via the column of wire 10 connected to the LED cathode via connector 70-a in order to illuminate that LED as part of a message. When messages are displayed, those of LEDs 52 that are part of the message need not be illuminated at the same time, so long as they are illuminated for a sufficiently long period that the human eye integrates their illumination into the appearance of constant illumination. In other words, the LEDs may be illuminated in a time-multiplexed manner. This will assist in reducing power consumption.

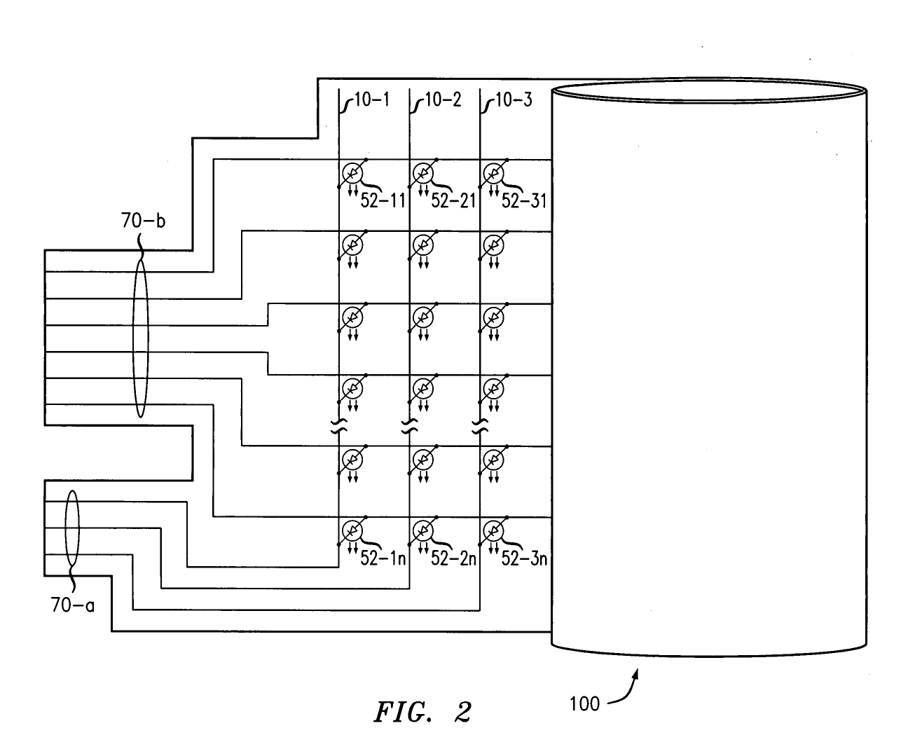

FIG. 2 shows display 100 in a partly rolled-up state. Display 100 can be easily rolled-up, transported, stored, and unfurled due to the flexibility of the substrate and wires.

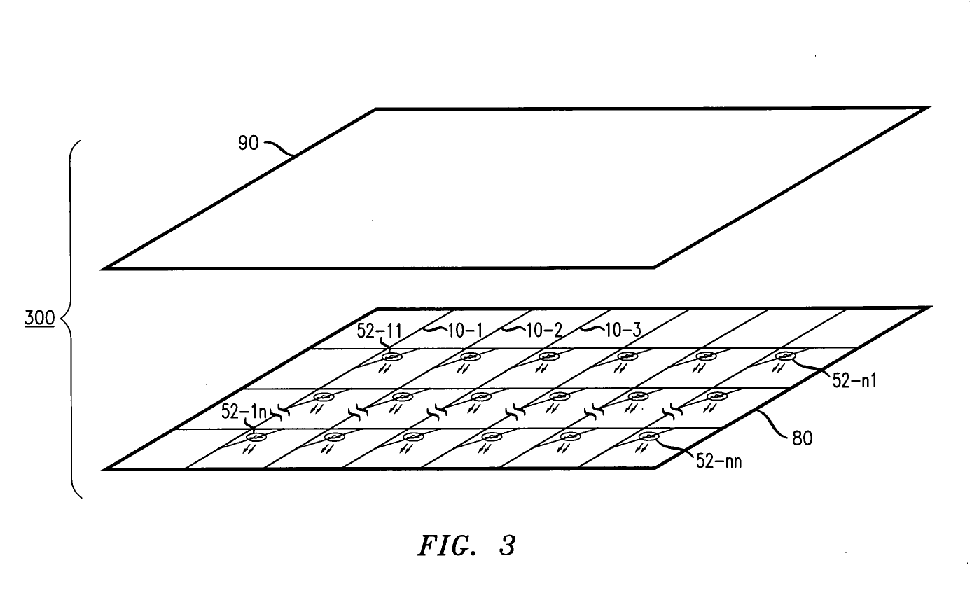

FIG. 3 shows an exploded view of another exemplary display 300 arranged in accordance with the principles of the invention. In this embodiment of the invention, a second thin flat sheet 90 of a flexible non-conducting material is bonded to substrate 80, sandwiching wires 10 and LEDs 52 between itself and substrate 80. An adhesive may be applied to the second sheet of flexible non-conducting material 90. A pressing process is employed to hold the second sheet in position covering the substrate 80, with a tight bond between the two sheets. The bonding of the second sheet 90 creates a seal which can protect wires 10 and LEDs 52 against infiltration by external environmental elements. The pressing process should have sufficient force to create the bond, but not so much force as to damage wires 10 and LEDs 52.

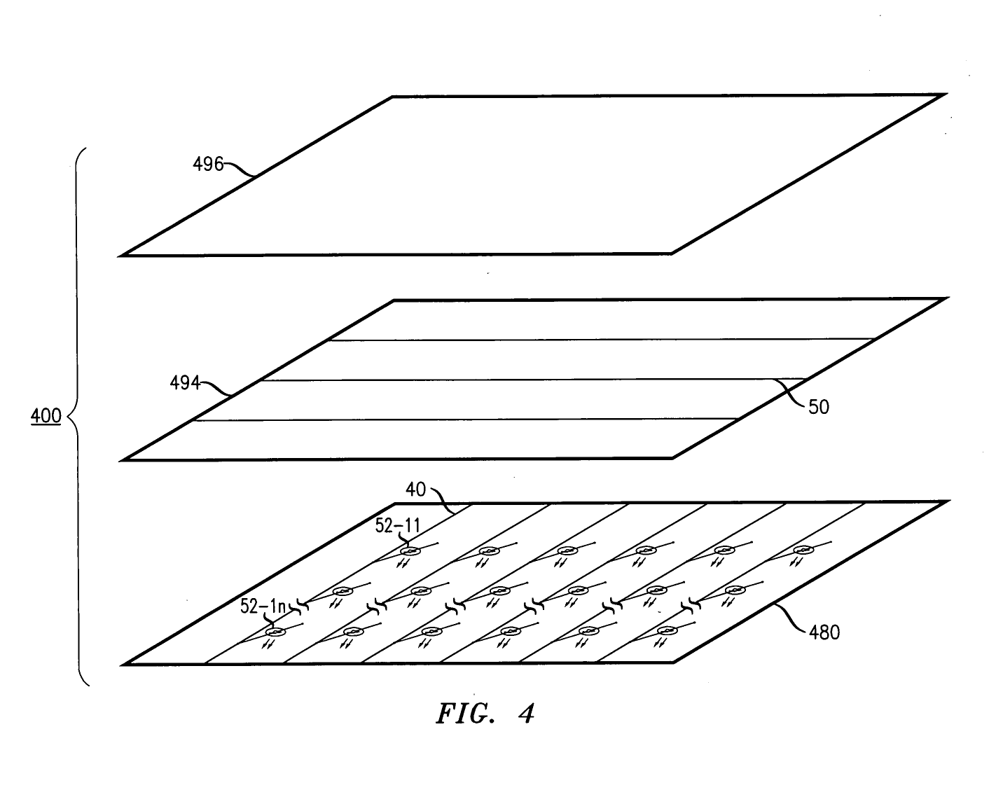

FIG. 4 shows an exploded view of an exemplary display 400 arranged in accordance with the principles of the invention. In display 400, low impedance wires 40 and low impedance wires 50 are non-insulated wires. The columns, i.e., wires 40, are coupled to the cathodes of LEDs 52 and bonded to a surface of a first sheet 480 of a thin flat flexible non-conducting material. The rows, 25 i.e., wires 50, are bonded to a surface of a second sheet 494 of a thin flat flexible non-conducting material. Wires 50 couple to the anodes of LEDs 52 when sheet 494 and sheet 480 are coupled. Sheet 494 may have pre-punched holes through which the cathodes of LEDs 52 may be coupled to wires 50.

Sheet 480 and sheet 494 are coupled to form a grid. Specifically, sheet 494 is positioned over sheet 480 and bonded thereon, with sheet 494 interposed between wires 50 and wires 40 to provide the necessary insulation for the wires. This forms a rectangular arrangement with the wires, with sheet 494 having wires 50 rows bonded thereon as a top layer over the coupled LEDs 52 and wires 40 columns on sheet 480.

An optional third sheet 496 of a flexible non-conducting material may be bonded with an adhesive to sheet 494. A pressing process is employed to hold sheet 496 in position covering sheet 494, with a tight bond between the two sheets. The bonding of sheet 496 creates a seal, which can protect wires 50, wires 40, and LEDs 52 against infiltration by external environmental elements. The pressing process should have sufficient force to create the bond, but not so much force as to damage wires 50, wires 40 and LEDs 52.

Note that the material for the three sheets of flexible non-conducting material need not be the same, although it is probably best if they are made of the same material, or at least if they are made of materials that have similar thermal characteristics.

Those skilled in the art will recognize that embodiments of the invention employing wire arrangements other than rectangular arrangements may be used. For example, trapezoidal, triangular, or even irregular wire arrangements may be used. Furthermore, those skilled in the art will recognize that there need not be two connectors, but instead, one or more connectors may be used. Also, the ends of the wires may form a connector. Finally, those skilled in the art will recognize that, although in the exemplary embodiment, the light source is shown as LEDs, any type of light source, e.g., incandescent lights, halogen lights, fluorescent lights, etc., may be used.

The foregoing merely illustrates the principles of the invention. It will thus be appreciated that those skilled in the art will be able to devise various arrangements, which, although not explicitly described or shown herein, embody the principles of the invention, and are included within its spirit and scope.

We claim:

1. A large display, comprising:
a first sheet of flexible non-conducting material;
a plurality of discrete flexible wires bonded to one surface of said first sheet, at least one of said wires having a low impedance segment; and
a plurality of display elements coupled to said wires.

2. The display of claim 1, wherein said first sheet is formed of a material selected from the group consisting of Kapton® and Mylar.

3. The display of claim 1, wherein at least one of said display elements is selected from the group consisting of light emitting diodes (LEDs), incandescent lights, halogen lights, and fluorescent lights.

4. The display of claim 1, wherein ends of said wires form a connector.

5. The display of claim 1, further comprising a connector, wherein said wires terminate at said connector.

6. The display of claim 1, wherein said low impedance segment is a copper wire.

7. The display of claim 1, wherein said low impedance segment has zero ohms for purposes of circuit analysis when analyzing a circuit containing said wire having said low impedance segment and the one of said LEDs to which it is coupled.

8. The display of claim 1, wherein said wires are adapted to be coupled to a programmable controller.

9. The display of claim 8, wherein said programmable controller is operable to illuminate at least one of said plurality of display elements.

10. The display of claim 9, wherein each one of said plurality of display elements need not be illuminated simultaneously.

11. The display of claim 1, wherein said wires coupled to said display elements are arranged at least in part in a rectangular grid pattern.

12. The display of claim 1, wherein said wires are insulated at least in part.

13. The display of claim 1, wherein said wires are bonded to said first sheet by an adhesive.

14. The display of claim 13, wherein said adhesive is of a type that seals continuously as it ages.

15. The display of claim 13, wherein said plurality of display elements are bonded to said first sheet by said adhesive.

16. The display of claim 1, further comprising a second sheet of flexible non-conducting material, said second sheet being positioned over said first sheet and bonded thereto, said wires and said plurality of display elements being positioned between said second sheet and said first sheet.

17. The display of claim 1, wherein said wires are non-insulated.

18. The display of claim 1, further comprising a second sheet of flexible non-conducting material, wherein a first group of said wires which are coupled to anodes of said display elements are bonded to said one surface of said first sheet, and the remaining ones of said wires that are not in said first group are bonded to said second sheet, and said second sheet being interposed between said first group of said wires and said remaining ones of said wires, said remaining ones of said wires being coupled to cathodes of said LEDs.

19. The display of claim 18, wherein a grid is formed at least in part by said wires when said second sheet is positioned over said first sheet and bonded thereto.

20. The display of claim 19, further comprising a third sheet of flexible non-conducting material, said third sheet being bonded to said second sheet.

21. A large display, comprising:
a first sheet of flexible non-conducting material;
a second sheet of flexible non-conducting material;
a first plurality of discrete flexible wires bonded to one surface of said first sheet;
a second plurality of discrete flexible wires bonded to one surface of said second sheet; and
a plurality of LEDs having anodes coupled to said first plurality of said discrete flexible wires;
wherein at least one of said first and second plurality of wires has a low impedance segment, and said second sheet is interposed between said first plurality of said discrete flexible wires and said second plurality of said discrete flexible wires, said second plurality of said discrete flexible wires being coupled to cathodes of said LEDs.

22. The display of claim 21, wherein said wires are non-insulated.

23. The display of claim 22, further comprising a third sheet of flexible non-conducting material, said third sheet being bonded to said second sheet.

24. A method of operating a large display, comprising the step of unfurling said display from a rolled-up position, wherein said display has a display area greater than 9.5 inches by 7 inches.

25. A method of operating a large display, said display having a plurality of discrete flexible wires bonded to one surface of a sheet of flexible non-conducting material, at least one of said wires having a low impedance segment, said wires being coupled to a plurality of display elements, said method comprising the steps of:
unfurling said display from a rolled-up position; and
illuminating ones of said display elements to display a message.

26. The method of claim 25, wherein said illuminating step further comprises the steps of:
transmitting a signal from a programmable controller to a wire connected to an anode of a display element; and
receiving said signal at said programmable controller after a voltage drop across said display element via a wire connected to a cathode of said display element.

27. The method of claim 25, wherein at least one of said display elements is illuminated in a time-multiplexed manner.
